(19) United States
(12) Patent Application Publication
(10) Pub. No.: US 2006/0207161 A1
(43) Pub. Date: Sep. 21, 2006

(54) Fishing rod carrier

(76) Inventor: Donald R. Lynn, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/084,799

(22) Filed: Mar. 18, 2005

(51) Int. Cl. A01K 97/10; A01K 97/08

(52) U.S. Cl. 43/21.2; 224/922; 43/26

(57) ABSTRACT

A fishing rod carrier has an elongated frame that is adjustable in length. At each end of the frame is a disk with several radial slots about the circumference. The slots are of a size to accept the shaft or butt of a fishing rod. On each disk there is a belt surrounding the circumference of the disk. The belts are attached near each midpoint leaving free ends. The free ends of each belt can be temporarily fastened together to span the slots and hold the rod in place.

### BACKGROUND OF THE INVENTION

1. Field of the Invention

This invention is directed to a hand carried apparatus for transporting several fishing rods in a spaced apart array.

2. Description of the Prior Art

Transporting several fishing rods and reels, by hand at one time, usually results in a tangled web of lines interwoven about the rods. In some cases, it takes some time to unscramble the mess. Many different types of equipment have been developed to carry several rods together but maintaining each rod separate from the others.

For example, U.S. Pat. No. 5,450,688, to Hall discloses a rod carrier having two wheels mounted on opposite ends of a frame. A carrying strap is attached to the frame. Each of the wheels has recesses in the periphery to accommodate the fishing rods and a base for support of the apparatus. Each wheel has a series of retainers adapted to span the mouth of each recess to hold the rods in place.

Sauder, U.S. Pat. No. 5,137,319, discloses a similar apparatus. The solid pedestal base of the device has several sockets to hold the butt ends of fishing rods. The base supports a post with an upper end unit with slots to hold the shafts of fishing rods. The post has a pivotable arm that acts in conjunction with the base as a tripod.

Another rod carrier is disclosed by Dorsey, U.S. Pat. No. 6,267,425, which has a frame with two blocks mounted thereon, one at each end. One block has a series of apertures therethrough and the other block has a series of slots in the periphery. The rods are carried in the slots and apertures. A hand grip is formed in the frame and cooperates with a bracket to support the apparatus on a wall. The frame also has belts attached to each end to wrap around the shafts of the rods to hold them in place. The ends of the belts have Velcro for fastening.

U.S. Pat. No. 5,803,519 to Daigle discloses an open rectangular frame work with sockets at one end and slots at the other end for carrying fishing rods. The frame work is adjustable in length for carrying different length rods.

What is needed in the art is a fishing rod carrier that is quick and easy to use, including loading and unloading different length rods and securing all the rods with one retainer at each end.

### SUMMARY OF THE PRESENT INVENTION

Therefore, it is an objective of this invention to provide a fishing rod carrier constructed for quick and easy loading and unloading of a plurality of different sized fishing rods.

It is another objective of this invention to provide a fishing rod carrier that is adjustable in length to accommodate different length rods.

It is a further objective of this invention to provide rod holders loadable and un-loadable by a to or fro motion.

It is yet another objective of this invention to provide each of the fishing rod holders with a retainer operative to free all rods, simultaneously.

### BRIEF DESCRIPTION OF THE FIGURES

FIG. 1 is a perspective of the rod carrier of this invention;

FIG. 2 is a perspective of a rod holder of this invention; and

FIG. 3 is a perspective of the rod carrier of this invention including several fishing rods.

### DETAILED DESCRIPTION OF THE INVENTION

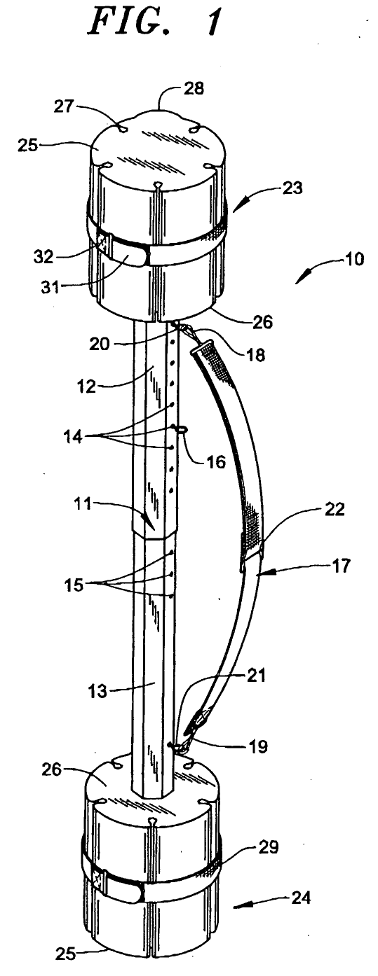

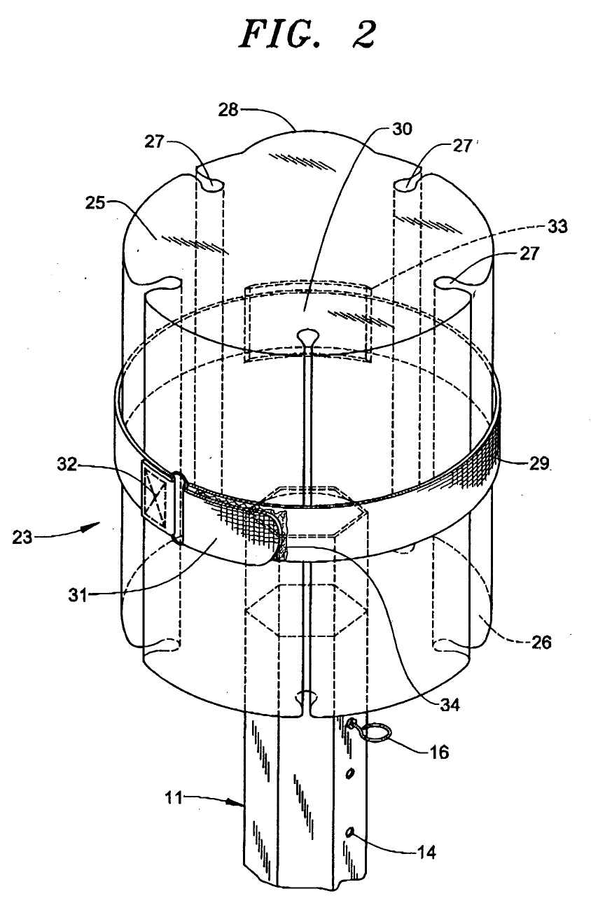

The rod carrier 10, as shown in FIG. 1, has a frame 11 with a first end 12 and a second end 13. The first end 12 and the second end 13 are slidably telescoped together to change the length of the frame and shorten or lengthen the distance between the rod holders. A series of apertures 14 is located on the first end 12 of the frame. A similar series of apertures 15 is located on the second end 13 of the frame. A removable pin 16, shown in FIG. 2, is inserted through aligned apertures in both ends of the frame to lock the frame in a desired length. Other locks may be used, for example, the second end may have spring loaded ball(s) that snap into the apertures of the first end of the frame.

A carrying strap 17 may be removably attached to the frame 11. In the illustrative, albeit non-limiting embodiment shown, the carrying strap has a spring loaded clip 18 and 19 at each end. Clip 18 snaps onto eye 20 on the first end of the frame and clip 19 snaps onto eye 21 on the second end of the frame. The length of the strap is adjustable through buckle 22.

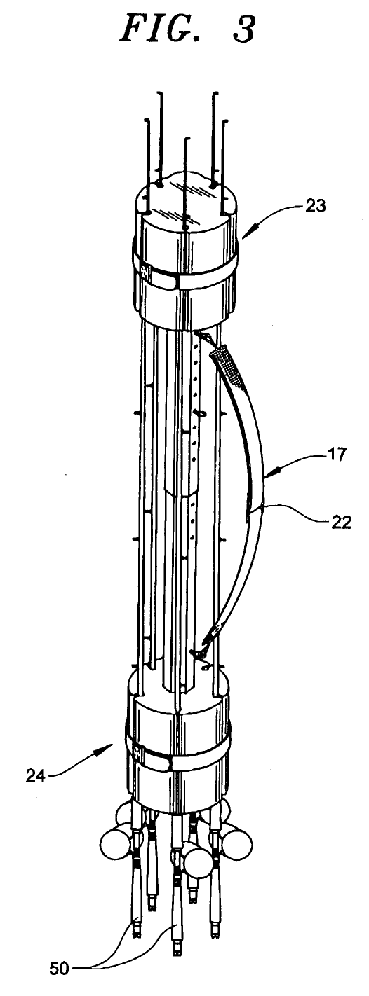

A first rod holder 23 is mounted on the first end 12 of the frame and a second rod holder 24 is mounted on the second end 13 of the frame 11. The rod holders may be identical or alternatively they may differ, for example in the dimensions of the radially disposed slots 27, which may be sized to accept the rod shafts, foregrips or rod butts as may be desired. The description of the first rod holder 23, shown in FIG. 2, generally applies to the second rod holder 24, as well. Each rod holder has the approximate form of a disk with a substantial thickness between the outer end 25 and the inner end 26 to add longitudinal stability to a fishing rod held in the holder, as shown in FIG. 3. The central portion of the holder 23 is mounted on the first end 12 of the frame with the disk diameter perpendicular to the longitudinal axis of the frame.

Several radial slots 27 are formed in the circumference of the disk to provide recesses for the shafts or butts of the fishing rods, as may be desired. The slots are deep enough for the shafts or butts to be entirely covered by the holder to prevent damage during transportation. The holder may be formed from a flexible or resilient material to have intimate contact with the rods. Each holder 23 and 24 has a ridge 28 substantially extending along its length from outer end 25 to inner end 26 to reinforce the disk structure and also, to act as a stop when the carrier is laid down. The ridge 28 is located between slots 27 and runs parallel to the longitudinal axis of the holder and to the slots 27.

A retainer 29 is attached to each holder. The retainer 29 is of a flexible material with a length sufficient to encircle the circumference of the disk as a belt. As illustrated in a preferred, albeit non-limiting embodiment in FIG. 2, the retainer is inserted through a slot 33, formed in the ridge 28 of the holder at about its mid-point 30. The free ends 31 and 32 of the retainer are fastened to each other to form a band surrounding the disk and spanning all the slots. An illustrative, but non-limiting fastening means is shown in FIG. 2, wherein one end 31 has a portion of hook and loop fastener fabric 34 attached thereto and the other end 32 has a loop through which the end 31 is reversed to fasten on a mating portion of hook and loop fastener material (not shown). Other fastening arrangements can be used, such as, buttons and holes, hooks and eyes, snaps, and tying.

In operation, the fishing rods 50 are loaded in the carrier by merely pushing the shafts or butts into the appropriately sized slots whereas to unload requires only pulling the shafts or butts from the slots. In addition, the opening and closing of the retainer secures or frees all the slots simultaneously.

The fishing rod carrier is made of lightweight materials to be easily portable by hand. The frame may be wood, metal or plastic. The disks may be of a pre-formed foam, wood, metal or plastic. The slots may be lined with a protective layer to prevent scratches to the shafts.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

I (We) claim:

1. A fishing rod carrier comprising an elongated frame having a first end and a second end, a first disk attached to said frame intermediate said first end and said second end, said first disk having an outer periphery, a plurality of radial slots spaced about said outer periphery, a retainer connected to said disk, said retainer removably spanning said slots at said periphery whereby several fishing rods may be temporarily retained in said slots.

2. A fishing rod carrier of claim 1 comprising a carrying strap having a first end and a second end, said first end and said second end attached to said frame at spaced apart points whereby said rod carrier can be supported.

3. A fishing rod carrier of claim 1 comprising said disk formed of a lightweight material, said retainer being an elongated flexible member attached to said periphery intermediate the length thereof with free ends, said ends temporarily secured together about said periphery whereby all rods are freed simultaneously.

4. A fishing rod carrier of claim 1 comprising a second disk attached to said frame intermediate said first end and said second end and spaced from said first disk, said second disk having an outer periphery, a second plurality of radial slots spaced about said outer periphery, the diameter of said first disk and said second disk approximately perpendicular to the longitudinal axis of said frame whereby several fishing rods may be temporarily retained in said slots at spaced points along the length thereof.

5. A fishing rod carrier of claim 4 comprising said first end of said frame and said second end of said frame being separate, said first end and said second end being longitudinally adjustably connected whereby fishing rods of different lengths can be temporarily retained.

6. A fishing rod carrier of claim 4 comprising a carrying strap having a first end and a second end, said first end and said second end attached to said frame at spaced apart points whereby said rod carrier can be supported.

7. A fishing rod carrier of claim 4 comprising said first disk and said second disk formed of a lightweight foam, said retainer being elongated flexible members each attached to said periphery of said first disk and said second disk intermediate the length thereof each with free ends, said free ends temporarily secured together about said periphery of said first disk and said second disk whereby all rods are secured simultaneously.

8. A fishing rod carrier adapted to transport several fishing rods comprising an elongated frame having a first end and a second end, a first disk attached to said first end of said frame with the diameter of said disk approximately perpendicular to the longitudinal axis of said frame, a second disk attached to said second end of said frame with the diameter of said disk approximately perpendicular to the longitudinal axis of said frame, a first plurality of radial slots formed in said first disk spaced about the circumference of said first disk, a second plurality of radial slots formed in said second disk spaced about the circumference of said second disk, a first elongated flexible retainer attached to said first disk intermediate the length thereof and having free ends, a second elongated flexible retainer attached to said second disk intermediate the length thereof and having free ends, said first retainer and said second retainer extending about said circumference of said first disk and said second disk, respectively, said free ends of said first retainer including fastening means thereon, said free ends of said second retainer including fastening means thereon, whereby said free ends of said first retainer can be temporarily secured about said first disk and said free ends of said second retainer can be temporarily secured about said second disk.

9. The fishing rod carrier of claim 8 comprising said first end and said second end of said frame slidably connected whereby the distance between said first disk and said second disk is adjustable.

10. The fishing rod carrier of claim 8 wherein at least one of said plurality of slots is lined with a protective layer, whereby scratching of the shafts is prevented.
